(19) United States
(12) Patent Application Publication
(10) Pub. No.: US 2017/0186457 A1
(43) Pub. Date: Jun. 29, 2017

(54) GRAPHENE AS A PROTECTIVE OVERCOAT FOR MAGNETIC MEDIA WITHOUT THE USE OF A NUCLEATION LAYER

(71) Applicant: National University of Singapore, Singapore (SG)

(72) Inventors: Wah Lawrence Ng, Kulim (MY); Andreas Volker Stier, Singapore (SG); Iñigo Martin Fernandez, Singapore (SG); Barbaros Özyilmaz, Singapore (SG); Antonio Helio Castro Neto, Singapore (SG)

(21) Appl. No.: 15/301,790

(22) PCT Filed: Apr. 7, 2015
(86) PCT No.: PCT/SG2015/000117

§ 371 Date: Oct. 4, 2016

Related U.S. Application Data
(60) Provisional application No. 61/976,240, filed on Apr. 7, 2014.

(51) Int. Cl. G11B 5/725; G11B 5/851; G11B 5/84; G11B 5/85; G11B 5/82; G11B 5/72

(52) U.S. Cl. CPC G11B 5/725; G11B 5/82; G11B 5/722; G11B 5/8408; G11B 5/85; G11B 5/851

(57) ABSTRACT

A graphene layer, used as an anti-corrosive protection medium for magnetic media, overcomes the existing problem of reducing the carbon overcoat layer thickness for magnetic media. Unlike the amorphous carbon that is currently used as an anti-corrosion layer, the impenetrability of graphene to all known gaseous substances enables full corrosion protection of the underlying magnetic medium with a layer of graphene that may be, for example, as thin as a single layer of graphene. The dry transfer of graphene onto magnetic recording disks is enabled, such that the resulting interface of the graphene with the magnetic layer is protested from contact with impurities.

### RELATED APPLICATION

This application claims the benefit of U.S. Provisional Application No. 61/976,240, filed on Apr. 7, 2014, the entire teachings of which application are incorporated herein by reference.

### BACKGROUND OF THE INVENTION

The requirement for higher clock speeds in transistors and higher data storage density in magnetic recording disks leads to the shrinkage of device dimensions to overcome those limitations. A key for higher storage density in magnetic recording devices is to minimize the distance between the magnetic read head and the magnetic medium. Conventionally, the space between the magnetic read head and the magnetic medium is covered with amorphous carbon, as an anti-corrosion material to protect the information stored on the magnetic medium.

### SUMMARY OF THE INVENTION

In accordance with a version of the invention, a graphene layer, used as an anti-corrosive protection medium for magnetic media, overcomes the existing problem of reducing the carbon overcoat layer thickness for magnetic media. Unlike the amorphous carbon that is currently used as an anti-corrosion layer, the impenetrability of graphene to all known gaseous substances enables full corrosion protection of the underlying magnetic medium with a layer of graphene that may be, for example, as thin as a single layer of graphene. The dry transfer of graphene onto magnetic recording disks is enabled, such that the resulting interface of the graphene with the magnetic layer is protected from contact with impurities.

In accordance with one version of the invention, a magnetic device comprises a magnetic substrate, and a graphene transfer stack comprising thermal release tape and graphene. A surface of the graphene of the graphene transfer stack is in contact with a surface of at least one of: (i) the magnetic substrate and (ii) an oxidation coating of the magnetic substrate.

In further, related versions, the graphene of the graphene transfer stack may comprise one and only one layer of graphene, or may comprise a plurality of layers of graphene. A surface of the thermal release tape may be in contact with a surface of the one and only one layer of graphene, or of the plurality of layers of graphene. The graphene transfer stack may further comprise a polymer. The magnetic device may, for example, comprise a magnetic medium, and the magnetic substrate may comprise a magnetic layer of the magnetic medium; or the magnetic device may comprise a magnetic head, and the magnetic substrate may comprise a magnetic transducer of the magnetic head. The oxidation coating may comprise a carbon thin film, such as diamond like carbon. Where the graphene transfer stack comprises a polymer, the polymer may comprise tribological properties such that the polymer is appropriate to be used as a lubricant layer in the magnetic device. The polymer may, for example, comprise polyvinylidene fluoride-co-trifluoroethylene or poly(methyl methacrylate). The polymer may comprise a thickness of between about 1 nanometer and about 2 micrometers.

In accordance with another version of the invention, there is provided a method of manufacturing a magnetic device. The method comprises contacting, with a surface of graphene of a graphene transfer stack, a surface of at least one of (i) a magnetic substrate and (ii) an oxidation coating of a magnetic substrate, the graphene transfer stack comprising thermal release tape and the graphene; and releasing the graphene of the graphene transfer stack from the thermal release tape to transfer the graphene of the graphene transfer stack to the surface of the at least one of (i) the magnetic substrate and (ii) the oxidation coating of the magnetic substrate.

In further, related versions, the method may comprise transferring one and only one layer of graphene, or transferring a plurality of layers of graphene, to the surface of the at least one of (i) the magnetic substrate and (ii) the oxidation coating of the magnetic substrate. The method may comprise applying heat and pressure to the graphene transfer stack to release the graphene of the graphene transfer stack from the thermal release tape. The applying heat and pressure may comprise at least one of: applying a roll-to-roll press to the graphene transfer stack; and applying a hot press to the graphene transfer stack. The method may further comprise forming the graphene transfer stack by: applying thermal release tape to at least one of: (i) a surface of graphene on a metallic substrate and (ii) a surface of at least one polymer layer overlaying a surface of graphene on a metallic substrate; and delaminating the graphene transfer stack from the metallic substrate. The graphene layer resulting from the transfer of graphene from the graphene transfer stack to the surface of at least one of (i) the magnetic substrate and (ii) the oxidation coating of the magnetic substrate may comprise an areal crack density of less than about 5 defects per 100×100 μm².

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a cross-sectional view of a typical magnetic hard disk medium, with a magnetic head flying on top of the magnetic medium, in accordance with the prior art.

FIG. 2 is a cross-sectional view of a magnetic medium with a graphene film as a protective overcoat, in accordance with a version of the invention.

FIG. 3 is a process flow chart for deposition of graphene on magnetic media, in accordance with a version of the invention.

FIG. 4A is a schematic process flow for preparation of a graphene transfer stack for single layer graphene, and for transfer of the graphene onto a target magnetic disk substrate, in accordance with a version of the invention. FIG. 4B is a schematic process flow for preparation of a graphene transfer stack for multilayer graphene, and for transfer of the graphene onto a target magnetic substrate, in accordance with a version of the invention.

FIGS. 5A-5D are schematic layer structures of graphene transfer stacks in accordance with a version of the invention, in which FIG. 5A shows single layer graphene combined with thermal release tape, FIG. 5B shows single layer graphene with supporting polymer and thermal release tape, FIG. 5C shows multilayer graphene and thermal release tape, and FIG. 5D shows multilayer graphene with supporting polymer and thermal release tape.

FIGS. 6A and 6B are schematic layer structures of graphene transfer stacks being applied to a magnetic substrate, in accordance with a version of the invention.

FIG. 7 is a schematic flow diagram of a method of manufacturing a magnetic device, in accordance with a version of the invention.

FIG. 8A is a plot of the distribution of defects in a monolayer of graphene that has been transferred onto a magnetic medium substrate via a thermal release tape technique in accordance with a version of the invention.

FIG. 8B is a comparative bar graph plot of corrosion density for CVD graphene versus graphene that has been transferred onto a magnetic substrate in accordance with a version of the invention.

### DETAILED DESCRIPTION OF THE INVENTION

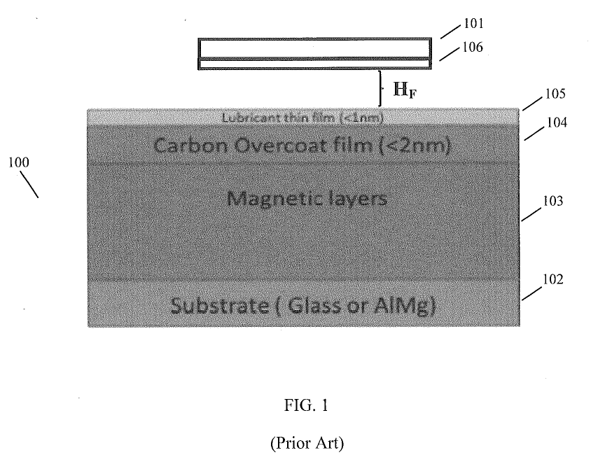

FIG. 1 is a cross-sectional view of a typical magnetic hard disk medium (or magnetic disk) 100, with a magnetic head 101 flying on top of the magnetic disk 100, in accordance with the prior art. The magnetic disk 100 is used to record data through signal output from the magnetic head 101, which includes a magnetic transducer 106. The magnetic disk 100 includes a substrate 102, which may be made, for example, of glass, aluminum or aluminum-magnesium alloy. The magnetic layers 103 of the disk 100 may be formed, for example, of multiple layers of a ferromagnetic metal, such as cobalt, deposited through sputtering. Above the magnetic layers 103, a protective overcoat 104, which is typically a carbon film, is deposited, for example by Plasma-Enhanced Chemical Vapor Deposition (PECVD), sputtering, Ion Beam Deposition (IBD) or other forms of thin film deposition method. The protective overcoat 104 is conventionally less than about 2 nm thick. Finally, a thin layer (for example, less than 1 nm thickness) of fluorine-based lubricant 105 is deposited, for example via a vapor-deposition method or a dip-and-pull method. The circular magnetic disk 100 rotates at high speed, for example, greater than 5000 rpm. The magnetic head 101 flies above the magnetic disk 100 at a height, shown as H_{F} in FIG. 1, of less than 10 nm away from the surface of the disk 100.

Galvanic corrosion tends to occur in the magnetic disk 100. This is due to moisture forming a conducting electrode between the metal magnetic thin films of the magnetic layers 103. The carbon thin film of the protective overcoat 104 acts as a protective shield for the magnetic layers 103. Due to the close proximity of the magnetic head 101 to the surface of the magnetic disk 100, the magnetic head 101 will hit the magnetic disk 100 even with the slightest movement of the hard disk drive in which the magnetic disk 100 is included.

The carbon thin film of the protective overcoat 104 should be as thin as possible, so that the magnetic head 101 can fly closer to the magnetic layers 103. By having the magnetic head 101 fly closer to the surface of the magnetic disk 100, one may obtain higher areal density for the magnetic disk 100, due to the reduction in magnetic head spacing.

A version of the invention permits a reduction in magnetic head spacing, while also maintaining the anti-corrosive properties of the protection layer.

A description of example embodiments of the invention follows.

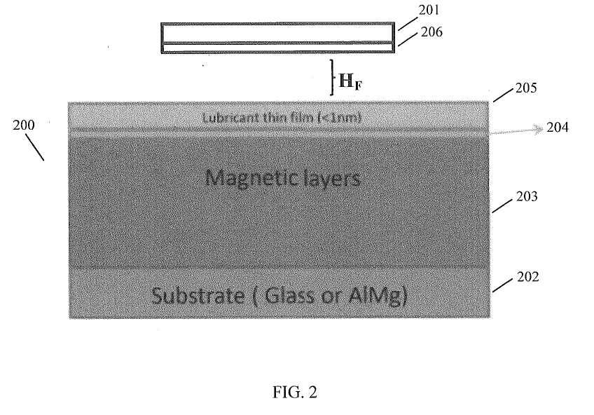

FIG. 2 is a cross-sectional view of a magnetic medium 200 with a graphene film as a protective overcoat 204, in accordance with a version of the invention. In the version of FIG. 2, a thin layer of graphene is used as a protective overcoat 204, without the need to apply a nucleation layer underneath the protective overcoat 204, as is typically required for a conventional carbon protective overcoat 104 (see FIG. 1) or for a graphene overcoat that is directly grown on the magnetic substrate. As a result of the ability to avoid the use of a nucleation layer, and of the use of thin layers of graphene, the graphene protective overcoat 204 of a version according to the invention can be thinner than a conventional amorphous carbon protective overcoat 104. The version of FIG. 2 also includes a substrate 202, magnetic layers 203 and a lubricant thin film 205, which can, for example, be formed by the conventional techniques described above for substrate 102, magnetic layers 103 and lubricant thin film 104 of FIG. 1. The magnetic head 201, its included magnetic transducer 206, and the magnetic head fly height, H_{F}, are also shown.

In general, the magnetic spacing for a magnetic medium may be calculated as follows:

T_{C}+T_{L}+H_{F}=M (Equation 1)

where T_{C} is the magnetic medium's carbon overcoat thickness, T_{L} is the lubricant film thickness, H_{F} is the magnetic head fly height, and M is the magnetic spacing for the magnetic medium.

From Equation (1), it can be seen that, other things being equal, minimizing the thickness, T_{C}, of the magnetic medium's carbon overcoat will result in a decrease in magnetic spacing, M, and hence produce a higher areal density capacity for the hard disk. Therefore, by having a thinner protective overcoat 204, the magnetic medium 200 of the version of FIG. 2 can have a higher areal density by virtue of having a thinner magnetic medium carbon overcoat thickness, T_{C}, which is the thickness of the protective overcoat 204. The thinner protective overcoat 204 of FIG. 2 can be without a nucleation layer, and can have a thickness of as little as the thickness of a single layer of graphene, which is the thinnest known form of crystalline carbon.

As described in further detail below, in accordance with an version of the invention, a graphene film is transferred to a magnetic disk via a dry transfer method to form the protective overcoat 204. The dry transfer is facilitated through the use of a thermal release tape. As the graphene is transferred onto the magnetic medium layer structure, there is no need for a catalyst layer for graphene growth. The thermal release tape, with graphene on one side, is placed onto the magnetic medium with no carbon thin film nucleation layer, or with a carbon film that is only a thin oxidation barrier and that is too thin to be an effective corrosion protection layer by itself. Heat and pressure facilitates the release of the graphene layer from the thermal release tape. For better results, the magnetic medium surface may be plasma etched to remove any oxidation film, prior to application of the graphene layer. A very thin oxidation barrier layer of carbon film may be deposited on the magnetic medium surface to prevent oxidation. This carbon thin film thickness should be sufficient to prevent or slow the immediate oxidation process, for example during manufacturing, but not thick enough to prevent corrosion over the long term.

In accordance with a version of the invention, the graphene layer, used as an anti-corrosive protection medium, overcomes the existing problem of reducing the carbon overcoat layer thickness. Unlike the amorphous carbon that is currently used as an anti-corrosion layer (such as conventional protective overcoat 104 of FIG. 1), the impenetrability of graphene to all known gaseous substances enables full corrosion protection of the underlying magnetic medium—for example with a single layer of graphene, which represents the ultimate thinnest carbon layer. Methods of application of graphene usually require either wet transfer techniques or the direct growth of graphene on a nucleation layer. However, those techniques are incompatible with magnetic memory disks, because they either increase the distance between the magnetic read head and the magnetic medium, as when a nucleation layer is used; or, in the case of metallic nucleation layers, screen the magnetic information; or, when wet transfer techniques are used, introduce humidity and/or moisture into the magnetic disk such that the integrity of the magnetic layer is compromised.

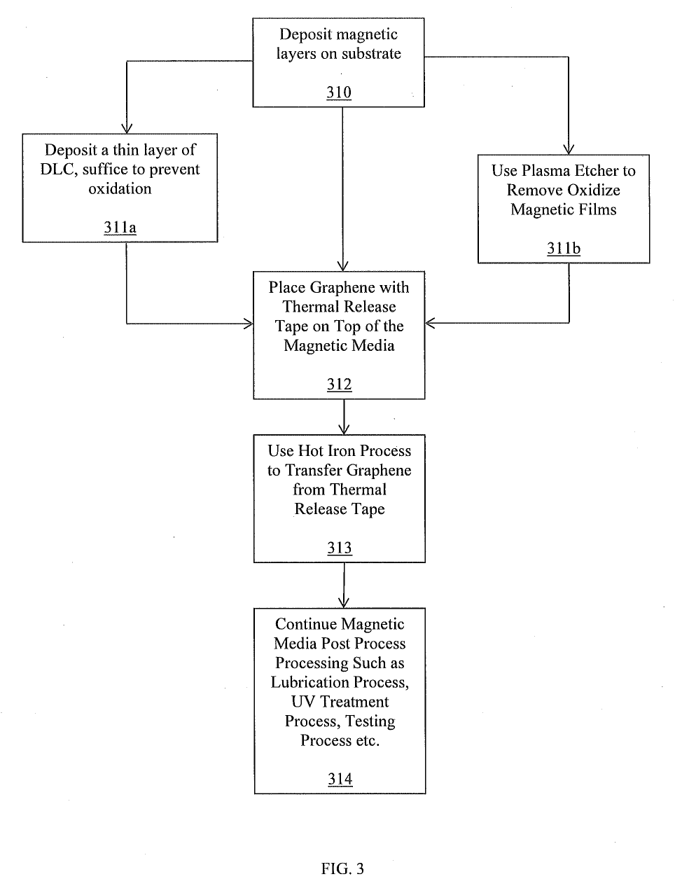

A method in accordance with a version of the invention enables the dry transfer of graphene onto a magnetic recording disk such that the resulting interface of the graphene with the magnetic layer is protected from contact with impurities. The graphene is embedded in the magnetic hard disk at a certain step in the production process. An example is depicted in FIG. 3.

FIG. 3 is a process flow chart for deposition of graphene on magnetic media, in accordance with a version of the invention. In step 310, magnetic layers 203 (see FIG. 2) are deposited onto the substrate 202. In step 311a, a thin oxidation coating, for example of diamond like carbon, may be deposited, in a thickness that is sufficient to prevent or slow the immediate oxidation process, for example during manufacturing, but not thick enough to prevent corrosion over the long term, such as a thickness of less than about 6 Angstroms, or between about 0.1 and about 0.6 nanometers. In step 311b, a plasma etcher may be used to remove any oxidation films on the surface of the magnetic layers 203. In step 312, graphene is placed on top of the magnetic medium using thermal release tape. In step 313, a process using heat and pressure, for example a hot press process, is used to transfer graphene from the thermal release tape onto the magnetic medium. In step 314, magnetic medium post-process processing is continued, for example a lubrication process, an ultraviolet light process, a testing process and any other post-process processing.

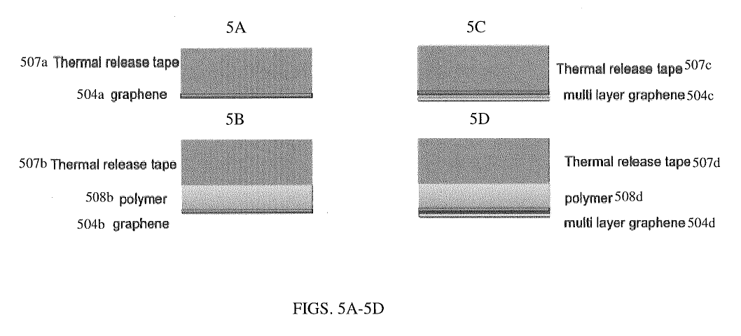

As used herein, a “graphene transfer stack” refers to a stack of materials that includes at least graphene and that is used to transfer graphene to a surface of a magnetic device, such as a magnetic medium, for example a magnetic hard disk. The graphene transfer stack may include a thermal release tape. For example, the graphene transfer stack may be any of those shown in FIGS. 5A-5D, which are discussed further below.

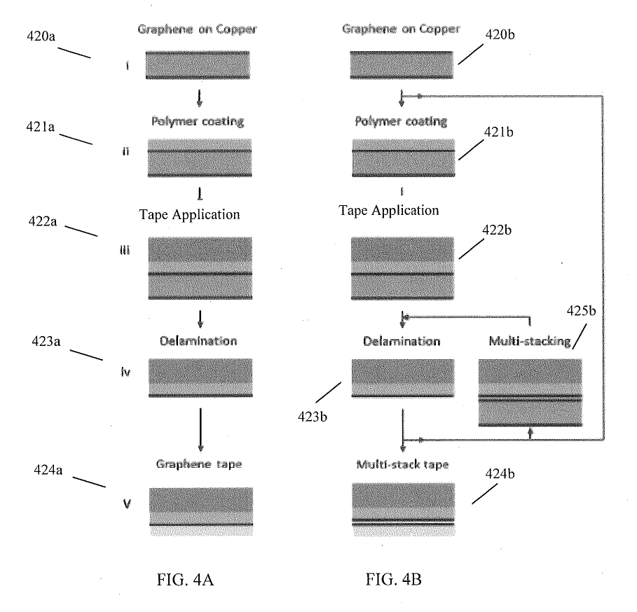

FIG. 4A is a schematic process flow for preparation of a graphene transfer stack for single layer graphene, and for transfer of the graphene onto a target magnetic disk substrate, in accordance with a version of the invention. FIG. 4B is a schematic process flow for preparation of a graphene transfer stack for multilayer graphene, and for transfer of the graphene onto a target magnetic substrate, in accordance with a version of the invention.

The process flows of FIGS. 4A and 4B are examples of possible process flows that may be used to fabricate the graphene transfer stacks shown in FIGS. 5A-5D, although it will be appreciated that other process flows may be used. Briefly, in steps 420a/420b of FIGS. 4A and 4B, graphene is grown on one or more surfaces of a metallic substrate, such as copper. In steps 421a/421b of FIGS. 4A and 4B, a polymer may be coated onto the graphene, and in steps 422a/422b of FIGS. 4A and 4B, thermal release tape is applied onto the polymer coating, for example by lamination. In steps 423a/423b of FIGS. 4A and 4B, the metallic substrate is delaminated from the stacks. In FIG. 4A, this results in a graphene transfer stack, shown at 423a, that may include the coated polymer and thermal release tape, on top of a single layer of graphene. This graphene transfer stack of 423a permits a single layer of graphene to be transferred to a magnetic medium, as shown at item 424a of FIG. 4A. Alternatively, as shown in FIG. 4B, multiple layers of graphene are formed on a transfer stack, by forming a multi-stack 425b as the combination of a delaminated stack 423b and a further graphene/metallic substrate combination 421b, and repeating the delamination 423b and multistacking 425b until a desired number of layers of graphene are formed. The multilayered graphene, once in final form, is transferred to a magnetic medium, as shown at item 424b of FIG. 4B.

FIGS. 5A-5D are schematic layer structures of graphene transfer stacks in accordance with a version of the invention, in which FIG. 5A shows single layer graphene 504a combined with thermal release tape 507a, FIG. 5B shows single layer graphene 504b with supporting polymer 508b and thermal release tape 507b, FIG. 5C shows multilayer graphene 504c and thermal release tape 507c, and FIG. 5D shows multilayer graphene 504d with supporting polymer 508d and thermal release tape 507d.

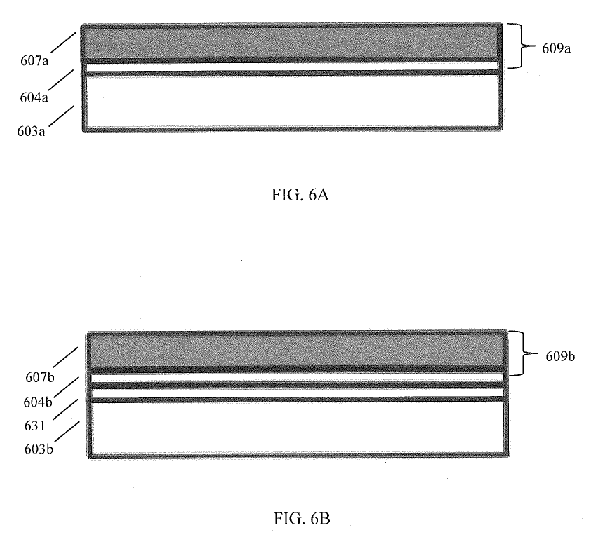

FIGS. 6A and 6B are schematic layer structures of graphene transfer stacks being applied to a magnetic substrate, in accordance with a version of the invention. In FIG. 6A, a graphene transfer stack 609a comprises thermal release tape 607a and graphene 604a, and is in contact with a surface of a magnetic substrate 603a. In FIG. 6B, a graphene transfer stack 609b comprises thermal release tape 607b and graphene 604b, and is in contact with an oxidation coating 631 of a magnetic substrate 603b.

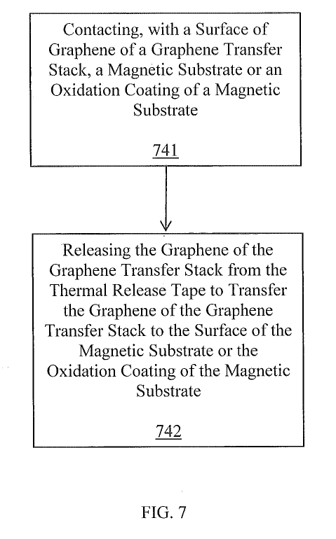

FIG. 7 is a schematic flow diagram of a method of manufacturing a magnetic device, in accordance with a version of the invention. In step 741, the method comprises contacting, with a surface of graphene of a graphene transfer stack, a surface of a magnetic substrate or an oxidation coating of a magnetic substrate. The graphene transfer stack comprises thermal release tape and the graphene. In step 742, the method comprises releasing the graphene of the graphene transfer stack from the thermal release tape to transfer the graphene of the graphene transfer stack to the surface of the magnetic substrate or the oxidation coating of the magnetic substrate.

Further details of steps of processes for fabrication of the graphene transfer stacks, such as those of FIGS. 5A-5D, in accordance with a version of the invention, are as follows in items (i) through (vii), below:
(i) An optimal starting material is a metallic substrate, where single layer graphene (SLG) has been grown on at least one of the surfaces of the metallic substrate, although other substrates and other types of graphene (such as bilayer or multilayer graphene) may be used. Cleaning steps to minimize contamination on the SLG surface can be implemented. These steps can be, but are not limited to, solvent cleaning, plasma treatment and thermal annealing.
(ii) Direct application of the thermal release tape 507a to the graphene 504a via a suitable application method (e.g., lamination) will result in a transfer stack as depicted in FIG. 5A. Alternatively, polymer layer deposition on top of SLG that is to form the transfer stack may be used, resulting in the transfer stack of FIG. 5B. Bar-coating or any other process resulting in the deposition of a thin polymer layer 508b on a surface such as, but not limited to, spin coating, spray coating, polymer evaporation, Langmuir-Blodgett deposition or direct deposition from melt, may be used to complete the deposition of the polymer layer 508b onto a transfer stack, such as that of FIG. 5B.
(iii) Application of the thermal release tape on top of the copper foil, SLG and polymer stack, for example, by lamination. An example of a thermal release tape 507a that may be used in accordance with versions of the invention is REVALPHA tape, sold by Nitto Denko Corporation of Osaka, Japan. It will be appreciated that other thermal release tapes may be used. The polymer 508b forming the transfer stack of FIG. 5B can be selected such that it will contribute to the properties and characteristics of the graphene transfer. In one version according to the invention, the thin polymer layer 508b may comprise tribological properties such that the polymer is appropriate to be used as a lubricant layer in the magnetic device. At least a portion of the thin polymer layer 508b can be intended to remain with the graphene after transfer to the magnetic substrate, so that the graphene is functionalized with respect to abrasion, such as from a magnetic read head. In one version according to the invention, the polymer layer 508b may comprise the co-polymer polyvinylidene fluoride-co-trifluoroethylene (henceforth referred to as P(VDF-TrFE)) or Poly(methyl methacrylate) (henceforth referred to as PMMA). The thickness of the polymer 508b is adjusted depending on optimal transfer characteristics, but usually has a thickness of more than 1 nanometer and less than 2 micrometers.
(iv) Delamination of the graphene transfer stack from the copper foil substrate (see 423a/423b of FIGS. 4A and 4B). This step could be completed by processes such as, but not limited to, chemical removal of the copper or chemical delamination.
(v) Multilayer graphene transfer stacks are fabricated as depicted in FIG. 4B. Processes that enable suitable surface treatment and/or surface functionalization for tailored properties can enhance the successive delamination and multi-stacking steps 423b/425b.
(vi) Application of the graphene transfer stack to the target substrate, such as magnetic layers 203 of FIG. 2. The graphene transfer stack has a structure as depicted, for example, in FIGS. 5A-5D. The graphene transfer stack is applied under suitable environmental conditions for optimal release of the thermal release tape 507a-d. The application of the graphene transfer stack to a surface will normally be based on the application of pressure and/or heat. Other application strategies such as, but not limited to, electrostatic binding could also be implemented for optimal release of the graphene layer 504a-d. Prior to the application of the graphene transfer stack, the target surface can be treated to minimize the presence of contaminants, through cleaning and/or plasma treatment, so as to promote adhesion/binding of the graphene 504a-d onto the magnetic disk surface. Pressure will aid at achieving a good bind of the graphene transfer stack with the destination surface. Heat will also aid at achieving a good connection between graphene and the substrate, but also, it could be the mechanism to delaminate the transfer tape from the graphene or polymer film. No residues from the tape should remain on the destination surface after delamination of the graphene transfer stack. The graphene transfer stack can be applied by techniques such as roll-to-roll or hot-press methods. A hot press can, for example, be at a temperature of 5 degrees C. above the release temperature of the tape reference; thus, if the tape releases at about 120 degrees C. according to the tape's specification, then the hot press temperature should be set at about 125 degrees C. A hot press can, for example, apply pressures below about 10 MPa, typically around 5 MPa. In one example, hot press techniques taught in Reference (1), below, the teachings of which reference are incorporated by reference in their entirety, may be used. In another example, roll-to-roll techniques taught in Reference (2), below, the teachings of which reference are incorporated by reference in their entirety, may be used.
(vii) Once the graphene has been applied to the surface, there may be post-application modification processes conducted to either the polymer or to the graphene layer. These may include, but are not limited to, electrical polarization or annealing. Such processes may assist in improving properties of the deposited structure or to improve the adhesion of additional layers on top of the graphene.

When assembling magnetic media in accordance with a version of the invention, oxidation to the magnetic layers can occur when removing the magnetic media from the sputtering machine. This can be overcome through the use of a plasma etcher to remove the oxidation. Alternatively, a very thin layer of carbon film can be coated onto the magnetic media, in a thickness that is sufficient to protect against immediate oxidation, but not long term corrosion, as discussed in connection with FIG. 3, above.

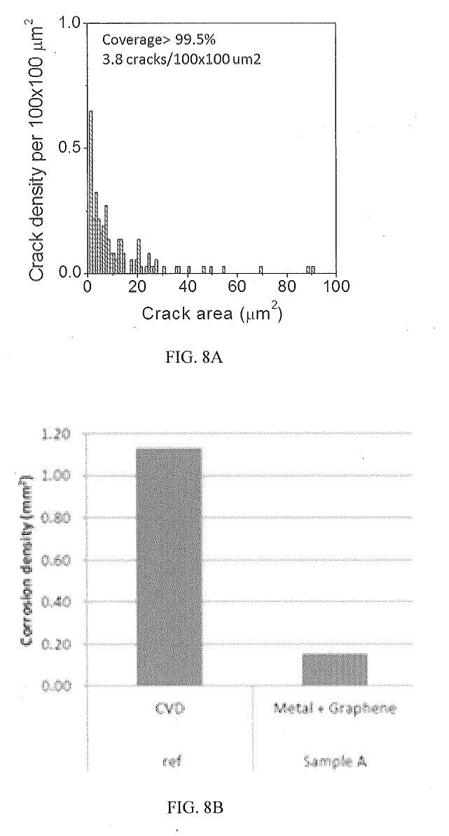

When a magnetic disk is coated with graphene in accordance with versions of the invention, graphene may fully cover, or substantially fully cover, the surface of the magnetic medium. As an example, FIG. 8A plots the distribution of defects (i.e., holes or cracks) in a monolayer of graphene that has been transferred onto a 2.5 inch diameter round magnetic medium substrate via a thermal release tape technique in accordance with a version of the invention. Results are shown as crack density per 100×100 μm² on the y-axis versus crack area (μm²) on the x-axis. With visible optics techniques, the graphene coverage was determined to be 99.5% and the areal density of defects was 3.8 cracks/holes per 100×100 μm². In one version according to the invention, the graphene layer resulting from the transfer of graphene from the graphene transfer stack to the surface of at least one of (i) the magnetic substrate and (ii) the oxidation coating of the magnetic substrate may comprise an areal crack density of less than about 5 defects (i.e., holes or cracks) per 100×100 μm².

FIG. 8B depicts the effectiveness of similar quality graphene as a corrosion protection barrier. Industry standard corrosion protection tests were conducted on a reference sample of similar quality CVD graphene (FIG. 8B, left) and graphene that was transferred onto a magnetic substrate in accordance with a version of this invention (FIG. 8B, right). Corrosion density (mm²) is shown on the y-axis. The test results confirm that graphene transferred in accordance with a version of this invention is a suitable corrosion protection layer of magnetic substrates according to industry standards.

A version according to the invention provides the advantage of reducing magnetic media carbon film thickness; and avoids the use of a nucleation layer, which increases magnetic spacing; and also avoids the use of chemicals to etch away the nucleation layer, which may result in corrosion to the magnetic media. A version according to the invention therefore can achieve a higher areal density for each magnetic medium. Industrial applications include, for example, protective coatings on hard disk drive magnetic media or magnetic heads.

As used herein, the term “graphene” is used to refer to: single layer graphene (SLG), bilayer graphene (BLG) and multilayer graphene (MLG).

As used herein, the term “oxidation coating” is used to refer to a coating that is thick enough to prevent or reduce the immediate oxidation process of an underlying substrate, for example during manufacturing, but that is not thick enough to prevent corrosion of the underlying substrate over the long term; such as a thickness of less than about 6 Angstroms, or between about 0.1 and about 0.6 nanometers. For example, such an oxidation coating may comprise a very thin film of carbon, such as diamond like carbon, such as in a thickness of between about 0.1 and about 0.6 nanometers.

As used herein, “thermal release tape” is a tape that releases from an underlying substrate upon application of heat, possibly in combination with pressure.

As used herein, a “magnetic device” includes any type of magnetic media, as well as magnetic heads. For example, where the magnetic device is a magnetic medium, the medium may include a magnetic layer, such as a layer 203 that includes ferromagnetic materials, which may be used, for example, as a recording medium in a hard disk. It will be appreciated that all manner of magnetic media are intended to be included under the terms “magnetic device” and “magnetic medium.” In another example, the term “magnetic device” may refer to a magnetic head, which may include a magnetic transducer, such as a disk read and/or write head, and more particularly a hard disk read/write head. It will be appreciated that all manner of such magnetic devices, magnetic heads and magnetic transducers may be coated with graphene in accordance with techniques taught herein. As used herein, the term “magnetic substrate” includes a portion of a magnetic device that is magnetic; thus, for example, in a magnetic medium, the magnetic substrate may be a magnetic layer such as 203 of FIG. 2; whereas in magnetic device, the magnetic substrate may be a magnetic transducer such as 206 of FIG. 2.

### REFERENCES

(1) U.S. Pat. No. 8,916,013 B2 of Hong et al., “Method for Transferring Graphene Using a Hot Press.”.

(2) U.S. Pat. No. 8,916,057 B2 of Hong et al., “Roll-to-roll Transfer Method of Graphene, Graphene Roll Produced by the Method, and Roll-to-Roll Transfer Equipment for Graphene.”

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

1. A magnetic device comprising:
a magnetic substrate; and
a graphene transfer stack comprising thermal release tape, a polymer and graphene, a surface of the graphene of the graphene transfer stack being in contact with a surface of at least one of: (i) the magnetic substrate and (ii) an oxidation coating of the magnetic substrate.

2. The device of claim 1, wherein the graphene of the graphene transfer stack comprises one and only one layer of graphene.

3.-4. (canceled)

5. The device of claim 1, wherein the graphene of the graphene transfer stack comprises a plurality of layers of graphene.

6.-7. (canceled)

8. The device of claim 1, wherein the magnetic device comprises a magnetic medium, and wherein the magnetic substrate comprises a magnetic layer of the magnetic medium.

9. The device of claim 1, wherein the magnetic device comprises a magnetic head, and wherein the magnetic substrate comprises a magnetic transducer of the magnetic head.

10. The device of claim 1, wherein the oxidation coating comprises a carbon thin film.

11. The device of claim 10, wherein the carbon thin film comprises diamond like carbon.

12. (canceled)

13. The device of claim 1, wherein the polymer comprises at least one of: polyvinylidene fluoride-co-trifluoroethylene and poly(methyl methacrylate).

14. The device of claim 1, wherein the polymer comprises a thickness of between about 1 nanometer and about 2 micrometers.

15. The device of claim 1, wherein the polymer comprises tribological properties such that the polymer is appropriate to be used as a lubricant layer in the magnetic device.

16. A method of manufacturing a magnetic device, the method comprising:
contacting, with a surface of graphene of a graphene transfer stack, a surface of at least one of (i) a magnetic substrate and (ii) an oxidation coating of a magnetic substrate, the graphene transfer stack comprising thermal release tape, a polymer and the graphene; and
releasing at least the graphene of the graphene transfer stack from the thermal release tape to transfer at least the graphene of the graphene transfer stack to the surface of the at least one of (i) the magnetic substrate and (ii) the oxidation coating of the magnetic substrate.

17. The method of claim 16, comprising transferring one and only one layer of graphene to the surface of the at least one of (i) the magnetic substrate and (ii) the oxidation coating of the magnetic substrate.

18. The method of claim 16, comprising transferring a plurality of layers of graphene to the surface of the at least one of (i) the magnetic substrate and (ii) the oxidation coating of the magnetic substrate.

19. The method of claim 16, comprising applying heat and pressure to the graphene transfer stack to release at least the graphene of the graphene transfer stack from the thermal release tape.

20. The method of claim 19, wherein the applying heat and pressure comprises at least one of: applying a roll-to-roll press to the graphene transfer stack; and applying a hot press to the graphene transfer stack.

21. The method of claim 16, further comprising forming the graphene transfer stack by:
applying thermal release tape to a surface of at least one polymer layer, which comprises the polymer to be used in the graphene transfer stack and which overlays a surface of graphene on a metallic substrate, the graphene on the metallic substrate comprising the graphene to be used in the graphene transfer stack; and
delaminating the graphene transfer stack from the metallic substrate.

22. The method of claim 16, wherein a graphene layer produced as a result of transferring the graphene of the graphene transfer stack to the surface of the at least one of (i) the magnetic substrate and (ii) the oxidation coating of the magnetic substrate comprises an areal crack density of less than about 5 defects per 100×100 μm².

23. The method of claim 16, further comprising releasing at least a portion of the polymer of the graphene transfer stack from the thermal release tape to transfer the at least a portion of the polymer, with the graphene of the graphene transfer stack, to the surface of the at least one of (i) the magnetic substrate and (ii) the oxidation coating of the magnetic substrate.

24. The method of claim 23, wherein the polymer comprises tribological properties such that the polymer is appropriate to be used as a lubricant layer in the magnetic device.

25. A magnetic device, comprising:
a magnetic substrate; and
a graphene transfer stack comprising thermal release tape, a polymer and graphene, a surface of the graphene of the graphene transfer stack being in contact with a surface of at least one of: (i) the magnetic substrate and (ii) an oxidation coating of the magnetic substrate,
the polymer comprising a thickness of between about 1 nanometer and about 2 micrometers, and the polymer comprising tribological properties such that the polymer is appropriate to be used as a lubricant layer in the magnetic device.
